(19) United States
(12) Patent Application Publication
(10) Pub. No.: US 2008/0095592 A1
(43) Pub. Date: Apr. 24, 2008

(54) Clamp For Joining An Add-On Piece To A Base

(75) Inventor: Uwe Spitz, Rheinfelden (DE)

Correspondence Address: BAKER & DANIELS LLP;111 E. WAYNE STREET, SUITE 800, FORT WAYNE, IN, 46802, US

(73) Assignee: A. RAYMOND & CIE, Grenoble (FR)

(21) Appl. No.: 11/722,909

(22) PCT Filed: Dec. 9, 2005
(86) PCT No.: PCT/EP05/13180

§ 371 Date: Jun. 27, 2007

(30) Foreign Application Priority Data
Dec. 31, 2004 (DE) 102004063686.9

(51) Int. Cl. F16B 37/04

(52) U.S. Cl. 411/174

(57) ABSTRACT

Disclosed is a clamp for joining an add-on piece (20) to a base (19). Said clamp comprises a base plate (1) and an opposite plate (5) which lies across from the base plate (1), is joined thereto via at least one connecting web (3), and is provided with an engaging arrangement (7, 8) that can be engaged with a fastening part (22). At least one pressing clip (9) is also provided. Said pressing clip (9) rests against the base (19) on the side facing the base plate (1) when the clamp is slid on the base (19). The or each pressing clip (9, 10) is attached to the side of the opposite plate (5) which faces the or each connecting web (3) while an inclined section (13) thereof extends to the base plate (1) such that a relatively great tolerance regarding the thickness of the base (19) is obtained while handling the clamp during mounting and removing is unproblematic.

### BACKGROUND OF THE INVENTION

1. Field of the Invention

The invention relates to a clamp for joining an add-on piece to a base.

2. Description of the Related Art

Such a clamp is known from U.S. Pat. No. 3,123,880. The prior clamp for joining an add-on piece to a base comprises a baseplate that is positionable between the base and the add-on piece and has a baseplate aperture through which a fastening element is to be passed. Also present is a counterplate, which is disposed opposite the baseplate and is connected thereto via at least one connecting web, and which comprises an engaging arrangement, in the form of a stamping, which can be brought into engagement with the fastening element. The prior clamp further comprises at least one pressure clip, which is attached by a bent transitional section to the counterplate on the opposite side from the or each connecting web, and in an arrangement wherein the clamp is pushed onto the base, bears against the base on the opposite side from the baseplate. The or each pressure clip comprises, both at the end facing the transitional section and at the end facing away from the transitional section, a respective contact region that bears against the base. Extending between the contact regions is a coupling region that is bowed in the direction of the counterplate and which, on the insertion of an add-on piece of a certain standard thickness that is to be joined to the base, bears against the counterplate and thus permits a relatively high tightening torque.

A clamp provided with a baseplate and a counterplate is known from U.S. Pat. No. 4,897,005. The baseplate and the counterplate are connected to each other by a connecting web. Configured on the counterplate is an engaging arrangement in the form of a nut, which can be brought into engagement with a fastening element in the form of a threaded screw. Formed onto the baseplate is a pressure clip, which extends in bent fashion, via an inclined section, from the end of the baseplate opposite from the connecting web in the direction of the counterplate, and is configured by means of a step structure adapted to the dimensions of the base to engage with an aperture that is provided in the base and to which the clamp is pre-affixed to guard against its being inadvertently pulled off before the fastening screw is tightened.

Known from DE 41 28 661 A1 is a clamp for joining an add-on piece to a base, which clamp comprises a baseplate that is positionable between the base and the add-on piece and has a baseplate aperture through which a fastening element configured as a quick-connect screw can be passed. Also present is a counterplate which is disposed opposite the baseplate and is connected thereto via at least one connecting web, and which comprises an engaging arrangement that can be brought into engagement with the fastening element. In an arrangement wherein the clamp is pushed onto the base, in a parallel arrangement of the baseplate, pressure clips bear against the base on the side facing the baseplate to hold the clamp on the base. Although this clamp yields satisfactory joining results, it has been found in practice that if the base is subject to thickness tolerances, with increasing thickness it becomes very difficult to push the clamp on and remove it, while with decreasing thickness there is a risk of it inadvertently detaching from the base.

### SUMMARY OF THE INVENTION

The subject of the invention is a clamp for joining an add-on piece to a base which, even when used with bases of different thickness, is held reliably on the respective base and is also very easy to push onto and remove from said base.

This object is achieved according to the invention by the fact that in the inventive clamp, pressure clips extend from the respective bent transitional section in the direction of the baseplate via a straight inclined portion. Each pressure clip comprises at its end bearing against the base a contact section that is bent back in the direction of the counterplate so that even bases that are configured very differently in terms of thickness can be disposed between the baseplate and the counterplate with relatively high clamping forces and can also be pulled off again. The inventive clamp is able to accommodate bases of very different thickness by virtue of the inclined section, which exerts a relatively high spring action and therefore pressure force on the base. The bent contact section ensures problem-free removal due to the fact that no intermeshing is involved in the clamping action.

Further suitable configurations of the invention are the subject matter of the dependent claims.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an exemplary embodiment of a clamp according to the invention;

FIG. 2 is a side view of the clamp according to FIG. 1; and

FIG. 3 is a side view of the clamp according to FIGS. 1 and 2 in an installed situation.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

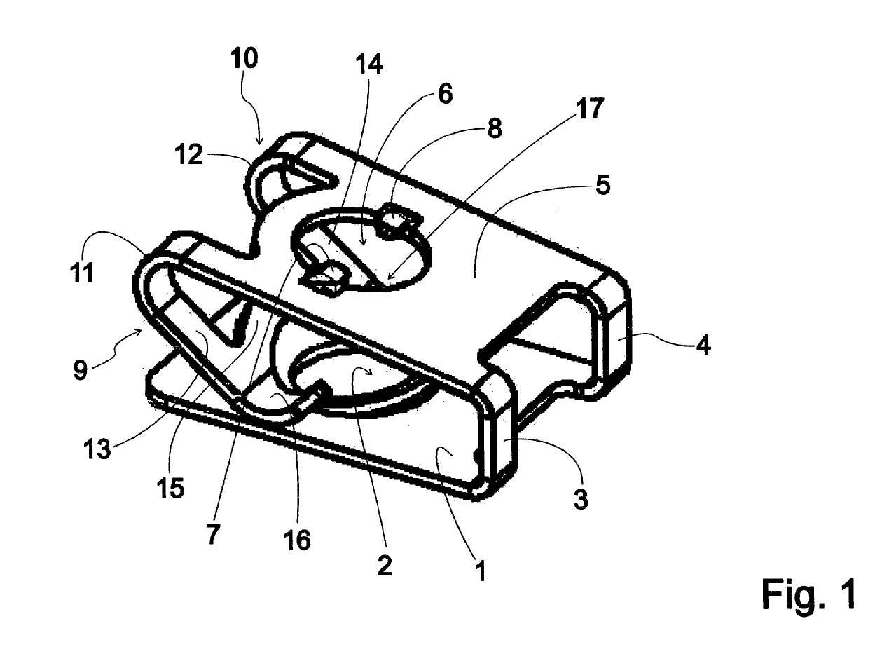

FIG. 1 is a perspective view of an exemplary embodiment of a clamp according to the invention. The inventive clamp, which is preferably made from sheet metal, comprises a flat, substantially rectangular baseplate 1, in which a roundish baseplate aperture 2 is provided in the central region. Formed outwardly on a narrow side of the baseplate 1 are a first connecting web 3 and a second connecting web 4, which extend substantially perpendicularly away from the baseplate 1.

A counterplate 5, which is also flat and is basically rectangular in shape, is attached by a narrow side to the ends of connecting webs 3, 4 pointing away from baseplate 1. Counterplate 5 has a counterplate aperture 6, also configured as roundish, that confronts baseplate aperture 2. A first latching lug 7 and a second latching lug 8 of an engaging arrangement extend radially inward from the edge of counterplate aperture 6 and are arranged diametrically opposite each other.

Formed on the narrow side of baseplate 5 that is opposite from connecting webs 3, 4, and juts beyond the edge of baseplate aperture 2 directed away from connecting webs 3, 4 are a first pressure clip 9 and a second pressure clip 10, respectively comprising a first transitional section 11 and second transitional section 12. Transitional sections 11, 12 are bent back in the direction of baseplate 1, and a first inclined section 13 and a second inclined section 14, respectively, are appended to the ends of transitional sections 11, 12 directed away from counterplate 5, and extend at an angle to the baseplate 1 in the direction of baseplate aperture 2.

In the exemplary embodiment shown, to couple the pressure clips 9, 10 together, the ends of inclined sections 13, 14 that are directed away from transitional sections 11, 12 are connected to each other via a circular-arc-shaped intermediate web 15 that approximately follows the outer contour of baseplate aperture 2. In addition, configured at the ends of inclined sections 13, 14 that are directed away from transitional sections 11, 12 are a first contact section 16 and a second contact section 17, which in the exemplary embodiment shown are bent back in the direction of counterplate 5 and are disposed relatively close to or in contact with the baseplate 1.

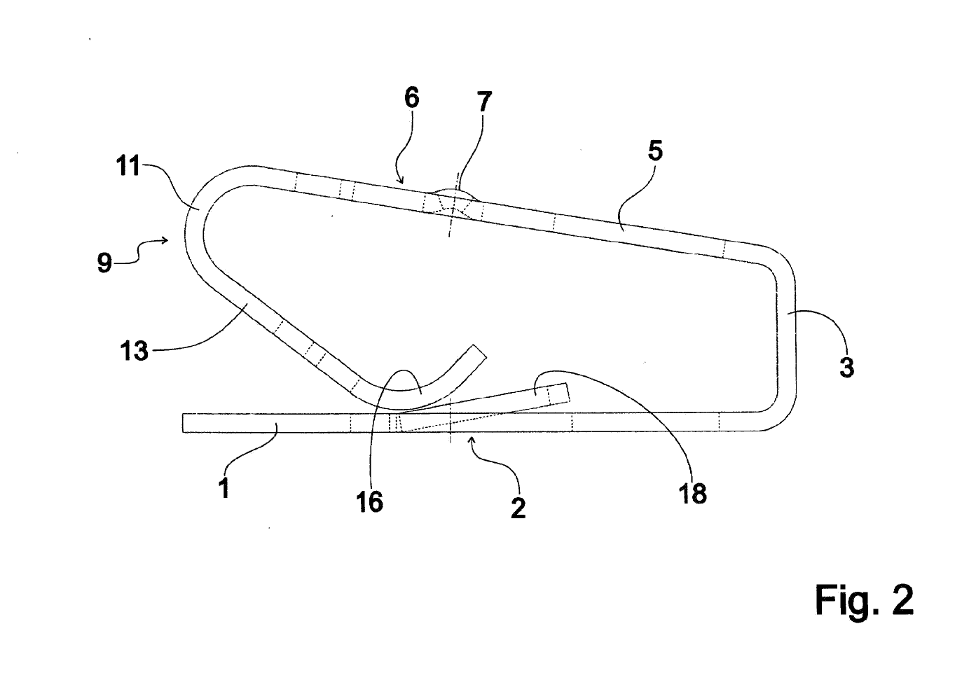

FIG. 2 shows the clamp according to FIG. 1 in a side view, in which it is clearly evident that given their angular orientation relative to each other, the distance between baseplate 1 and counterplate 5 increases in a direction extending away from connecting webs 3, 4. It can also be appreciated from FIG. 2 that configured in the region of baseplate aperture 2 is a latching tongue 18 that extends both in the direction of connecting webs 3, 4 and in the direction of counterplate 5.

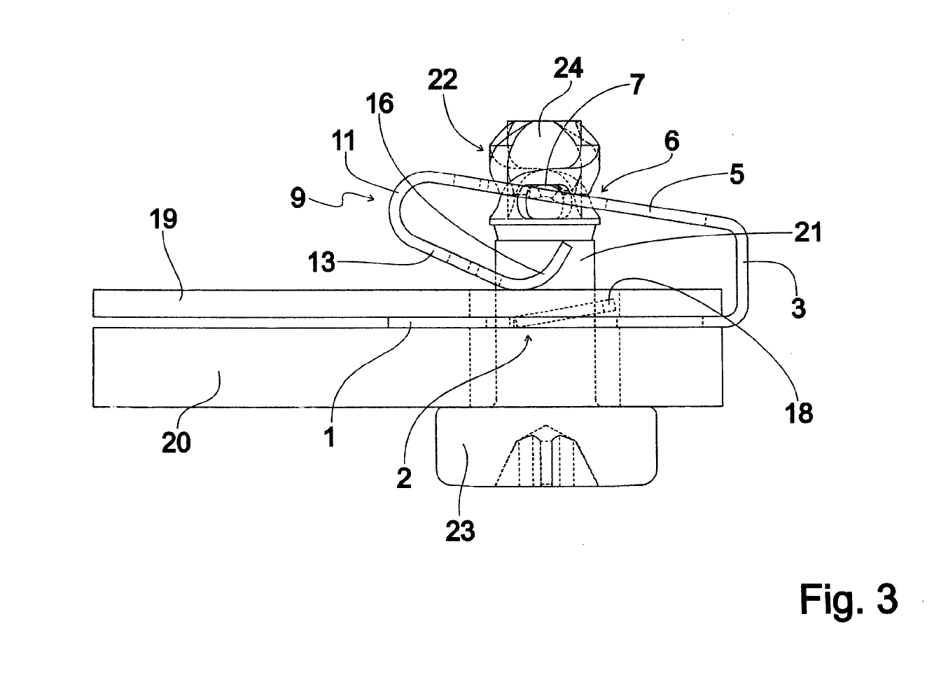

FIG. 3 is a side view of the exemplary embodiment according to FIGS. 1 and 2 in an installed situation, with a base 19 and an add-on piece 20 to be joined to said base 19. It can be seen from FIG. 3 that in the joining region, base 19 and add-on piece 20 have flat sides that are oriented substantially parallel to each other, between which baseplate 1 is inserted. A shaft 21 of a quick-connect screw 22 serving as a fastening element is inserted through baseplate aperture 2, is passed through both base 19 and add-on piece 20, bears by a screw head 23 against the opposite side of add-on piece 20 from baseplate 1, and comes into engagement via a head portion 24 with latching lugs 7, 8.

In the installed situation, pressure clips 9, 10 bear under bias against the opposite side of base 19 from baseplate 1 and, together with latching tongue 18, securing the inventive clamp to the base 19 prior to the engagement of the head portion 24 of quick-connect screw 22 with latching lugs 7, 8.

It can readily be appreciated from FIG. 3 that due to the comparatively generously dimensioned space between baseplate 1 and counterplate 5, the thickness of base 19 can vary within relatively large tolerances, to such an extent that latching lugs 7, 8 reliably come into engagement with head portion 24 of quick-connect screw 22, while at the same time the clamp is also very easy to handle when being pushed onto base 19 or removed from base 19. The flexibility of connecting webs 3, 4 and transitional sections 11, 12 also contributes to the thickness tolerance; moreover, their bending properties are fairly easy to adjust from a production engineering standpoint by using a larger width to achieve a higher bending resistance or a smaller width for a lower bending resistance.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A clamp for joining an add-on piece (20) to a base (19), comprising a baseplate (1) that is positionable between said base (19) and said add-on piece (20) and has a baseplate aperture (2) through which a fastening element (22) is to be passed; comprising a counterplate (5), which is disposed opposite said baseplate (1) and is connected thereto via at least one connecting web (3, 4), and which comprises an engaging arrangement (7, 8) that can be brought into engagement with said fastening element (22); and comprising at least one pressure clip (9, 10), which, in an arrangement wherein said clamp is pushed onto said base (19), bears against said base (19) on the opposite side from said baseplate (1), characterized in that the or each said pressure clip (9, 10) is attached to the opposite side of said counterplate (5) from the or each said connecting web (3, 4) and extends via an inclined section (13, 14) to said baseplate (1).

2. The clamp as in claim 1, characterized in that the or each said pressure clip (9, 10) comprises a bent transitional section (11, 12) between said counterplate (5) and said inclined section (13, 14).

3. The clamp as in claim 1 or claim 2, characterized in that the or each said pressure clip (9, 10) comprises, on the end that bears against said base (19) when said clamp is properly arranged, a contact section (16, 17) that is bent back in the direction of said counterplate (5).

4. The clamp as in one of claims 1 to 3, characterized in that two pressure clips (9, 10) are present that are disposed marginally on said counterplate (5).

5. The clamp as in claim 4, characterized in that said pressure clips (9, 10) are connected to each other in the end region via an intermediate web (15).
